(19) United States
(12) Patent Application Publication
(10) Pub. No.: US 2010/0295935 A1
(43) Pub. Date: Nov. 25, 2010

(54) ON-HEAD COMPONENT ALIGNMENT USING MULTIPLE AREA ARRAY IMAGE DETECTORS

(76) Inventors: Steven K. Case, St. Louis Park, MN (US); Timothy A. Skunes, Mahtomedi, MN (US); David W. Duquette, Minneapolis, MN (US); Sean D. Smith, Woodbury, MN (US); Beverly Caruso, St. Louis Park, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/769,151

(22) Filed: Apr. 28, 2010

Related U.S. Application Data
(60) Provisional application No. 61/175,911, filed on May 6, 2009.

(51) Int. Cl. H04N 7/18

(52) U.S. Cl. 348/95; 348/E07.085

(57) ABSTRACT

A sensor for sensing component offset and orientation when held on a nozzle of a pick and place machine is provided. The sensor includes a plurality of two-dimensional cameras, a backlight illuminator and a controller. Each camera has a field of view that includes a nozzle of the pick and place machine. The backlight illuminator is configured to direct illumination toward the plurality of two-dimensional cameras. The backlight illuminator is positioned on an opposite side of a nozzle from the plurality of two-dimensional cameras. The controller is coupled to the plurality of two-dimensional cameras and the backlight illuminator. The controller is configured to determine offset and orientation information of the component(s) based upon a plurality of backlit shadow images detected by the plurality of two-dimensional cameras. The controller provides the offset and orientation information to a controller of the pick and place machine.

### CROSS-REFERENCE TO RELATED APPLICATION

The present application is based on and claims the benefit of U.S. provisional patent application Ser. No. 61/175,911, filed May 6, 2009, the content of which is hereby incorporated by reference in its entirety.

### COPYRIGHT RESERVATION

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Pick and place machines are generally used to manufacture electronic circuit boards. A blank printed circuit board is usually supplied to the pick and place machine, which then picks individual electronic components from component feeders, and places such components upon the board. The components are held upon the board temporarily by solder paste, or adhesive, until a subsequent step in which the solder paste is melted or the adhesive is fully cured. The individual electronic components must be placed precisely on the circuit board in order to ensure proper electrical contact, thus requiring correct angular orientation and lateral positioning of the component upon the board.

Pick and place machine operation is challenging. In order to drive the cost of the manufactured circuit board down, the machine must operate quickly to maximize the number of components placed per hour. However, as the state-of-the-art of the electronics industry has advanced, the sizes of the components have decreased and the density of interconnections has increased. Accordingly, the acceptable tolerance on component placement has decreased markedly. Actual pick and place machine operation often requires a compromise in speed to achieve an acceptable level of placement accuracy.

One way in which pick and place machine operation is efficiently sped up is in the utilization of a sensor that is able to accurately evaluate both the position and angular orientation of a picked component upon a nozzle or vacuum quill, while the component is in transit to the placement site. Such sensors essentially allow the task of determining the component position and orientation upon the vacuum quill to be performed without any impact on placement machine speed, unlike systems that require separate motion to a fixed alignment sensor. Such sensors are known, and are commercially available from CyberOptics Corporation, of Golden Valley, Minn., under the trade designation Model LNC-60. Several aspects of these sensors are described in U.S. Pat. Nos. 5,278,634; 6,490,048; and 6,583,884.

Some implementations of optical on-head component measurement have observed the shadow cast by a backlit component at different angles of component rotation to calculate the original component orientation and position. A thin measurement ribbon is defined by the illumination and the detector, which is, typically, a linear detector. Components must be positioned properly in this ribbon to create a complete or nearly-complete shadow on the detector. This requires high precision motion actuation along the axis of rotation when the component itself is thin. Thin components, such as bare die or small passives, are becoming more common.

The component is rotated and the changing extent of the shadow is analyzed to determine the extent of the component shadow at each measurement and, from this, the original offset and orientation. Often the light source is nearly collimated and the receiving optics are nearly telecentric to simplify processing of the shadow. Experience shows that this method is accurate and fast for a wide range of components. Because linear detector pixels are, typically, only a few μm high, a single mote of debris can easily obscure one or more pixels. Noise and imperfections in the image or illumination can mimic the edge of the shadow, resulting in errors in shadow analysis. The minimum diameter of a telecentric imaging system is necessarily larger than the diagonal of the FOV, so a sensor for large components must have a single, large, and costly optical system to provide a continuous FOV with no gaps.

Recently, a component placement unit has been proposed by Joseph Horijon in European Patent Application EP 1 840 503 A1 that addresses some of the previous limitations of linear detector-based laser alignment systems. Specifically, the Horijon application proposes the use of a single two-dimensional imager to detect component position and orientation for up to four components simultaneously. While the Horijon application represents an improvement to the art of component alignment and position sensor for pick and place machine, additional room for improvement remains.

### SUMMARY

A sensor for sensing component offset and orientation when held on a nozzle of a pick and place machine is provided. The sensor includes a plurality of two-dimensional cameras, a backlight illuminator and a controller. Each camera has a field of view that includes a nozzle of the pick and place machine. The backlight illuminator is configured to direct illumination toward the plurality of two-dimensional cameras. The backlight illuminator is positioned on an opposite side of a nozzle from the plurality of two-dimensional cameras. The controller is coupled to the plurality of two-dimensional cameras and the backlight illuminator. The controller is configured to determine offset and orientation information of the component(s) based upon a plurality of backlit shadow images detected by the plurality of two-dimensional cameras. The controller provides the offset and orientation information to a controller of the pick and place machine.

### BRIEF DESCRIPTION OF THE DRAWINGS

FIG. 1 is a diagrammatic view of a Cartesian pick and place machine with which embodiments of the invention can be practiced.

FIG. 2 is a diagrammatic tomographic reconstruction of a component in accordance with an embodiment of the present invention.

FIG. 3a is a diagrammatic image of two example components held on nozzles in one field of view.

FIG. 3b is a diagrammatic image illustrating a selection of a subset of a field of view in accordance with an embodiment of the present invention.

FIG. 4 is a diagrammatic top plan view of a plurality of components being detected using a plurality of two-dimensional image detectors in accordance with an embodiment of the present invention.

FIG. 5a is a diagrammatic top plan view of a plurality of components being detected using a plurality of two-dimensional image detectors in accordance with another embodiment of the present invention.

FIG. 5b is a diagrammatic top plan view of a plurality of components being detected using a plurality of two-dimensional image detectors in accordance with another embodiment of the present invention.

FIG. 5c is a diagrammatic top plan view of a plurality of components being detected using a plurality of two-dimensional image detectors having overlapping fields of view in accordance with an embodiment of the present invention.

FIG. 6 is a diagrammatic top plan view of a plurality of components of different sizes being detected using a plurality of two-dimensional image detectors in accordance with an embodiment of the present invention.

FIG. 7 is a diagrammatic top plan view of a single large component being detected using a plurality of two-dimensional image detectors in accordance with an embodiment of the present invention.

FIG. 8 is a diagrammatic view of an improperly picked component being held on a nozzle.

FIG. 9 is a flow diagram of a method of detecting component position and alignment after a pick operation in accordance with an embodiment of the present invention.

FIG. 10 is a flow diagram of a method of detecting component position and alignment after a pick operation in accordance with another embodiment of the present invention.

### DETAILED DESCRIPTION OF ILLUSTRATIVE EMBODIMENTS

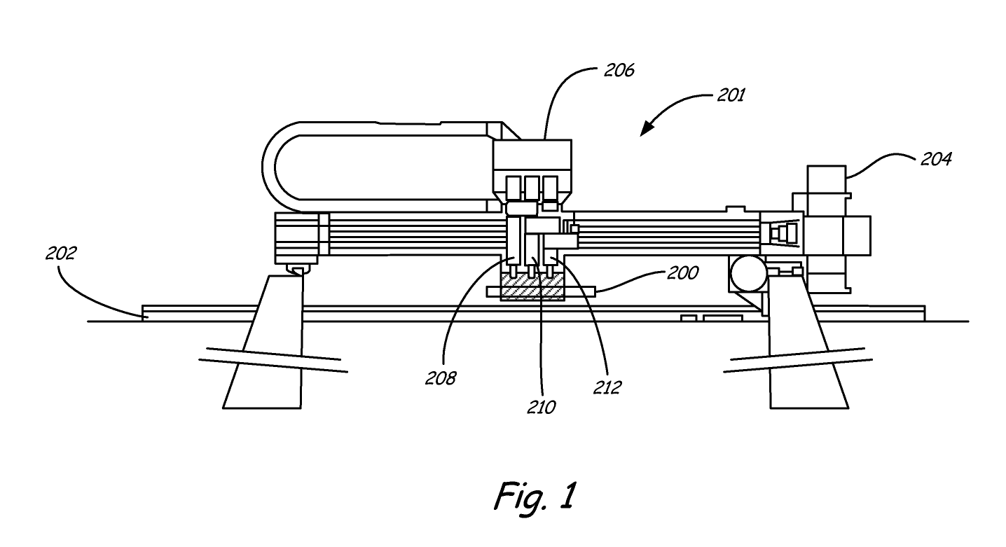

FIG. 1 is a diagrammatic view of an exemplary Cartesian pick and place machine 201 with which embodiments of the present invention are applicable. Pick and place machine 201 receives a workpiece, such as circuit board, via transport system or conveyor 202. A placement head 206 then obtains one or more electrical components to be mounted upon the workpiece from component feeders (not shown) and undergoes relative motion with respect to the workpiece in x, y and z directions to place the component in the proper orientation at the proper location upon the workpiece. The relative motion can be generated by moving the placement head; moving the workpiece; or a combination thereof. Placement head 206 may include an alignment sensor 200 that is able to calculate or otherwise determine position and orientation of one or more components held by nozzles 208, 210, 212 as placement head 206 moves the component(s) from pickup locations to placement locations.

Embodiments of the present invention generally provide an optical, on-head component offset and orientation measurement device that employs a plurality of two-dimensional detector arrays, imaging optics, and a diffuse backlight. The two-dimensional cameras' focal planes are nearly coincident with a plane passing through the center of rotation of a component. Each camera has sufficient depth of field to produce a reasonably sharp shadow edge from the component over all or most rotation angles. A two-dimensional image allows the sensor to tolerate much less strict positioning of the component in the illumination field. The source illumination is preferably generated by an unstructured, diffuse backlight opposite the cameras. The illuminator need only fill the useful field of view (FOV) of the image, without precise positioning relative to the imaging optics. The illumination source may employ some optics to facilitate efficient aiming of the light and to produce an approximately uniform intensity across the FOV of the camera. Camera optics can be telecentric or non-telecentric. Non-telecentric optics allows for cameras that are narrower in width than the FOV, enabling measurement of components that are larger than the physical dimensions of a single camera and measurement devices using multiple cameras with FOVs overlapped. Coordinated data collection from several cameras allows successful measurement of very large components. The width of the effective measuring region of a sensor with multiple overlapped FOVs can be as large as needed.

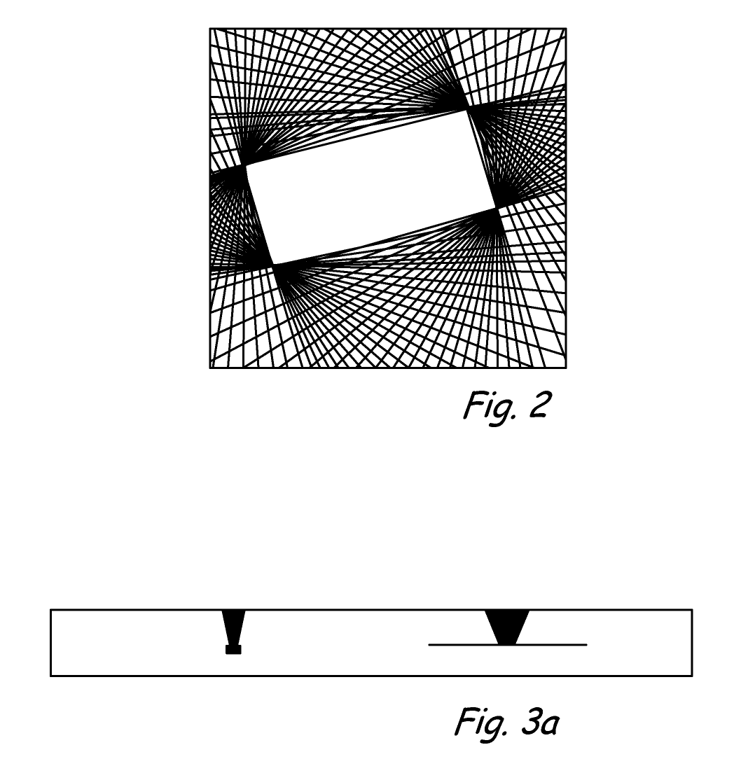

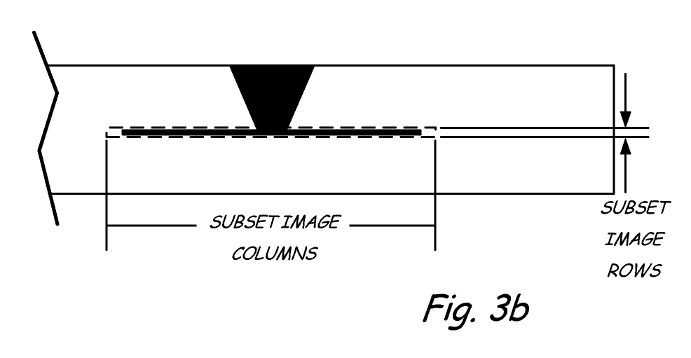

FIG. 2 is a diagrammatic tomographic reconstruction of a component. The actual technique for tomographic reconstruction can be any suitable technique, including that set forth in U.S. Pat. No. 6,583,884. FIG. 3a is a diagrammatic image of two components held on two adjacent nozzles viewed in a single FOV of a two-dimensional detector. The first component is typical of a small component in common use. The second component is a flat component typical of common larger, thin components. Because more than a single one-dimensional line of pixels is acquired, the most useful image subsets from the two-dimensional images can be used in processing the images. This selection of image subset fields of view may occur through calibration or be dynamically calculated in software as the data is collected. Statistical techniques applied to multiple lines of data will suppress noise, enhance detection of thin component shadows, and reject debris and defect signatures.

FIG. 3b is a diagrammatic image illustrating a selection of a subset of a field of view in accordance with an embodiment of the present invention. The subset is illustrated in phantom and may include a subset of columns as well as a subset of rows.

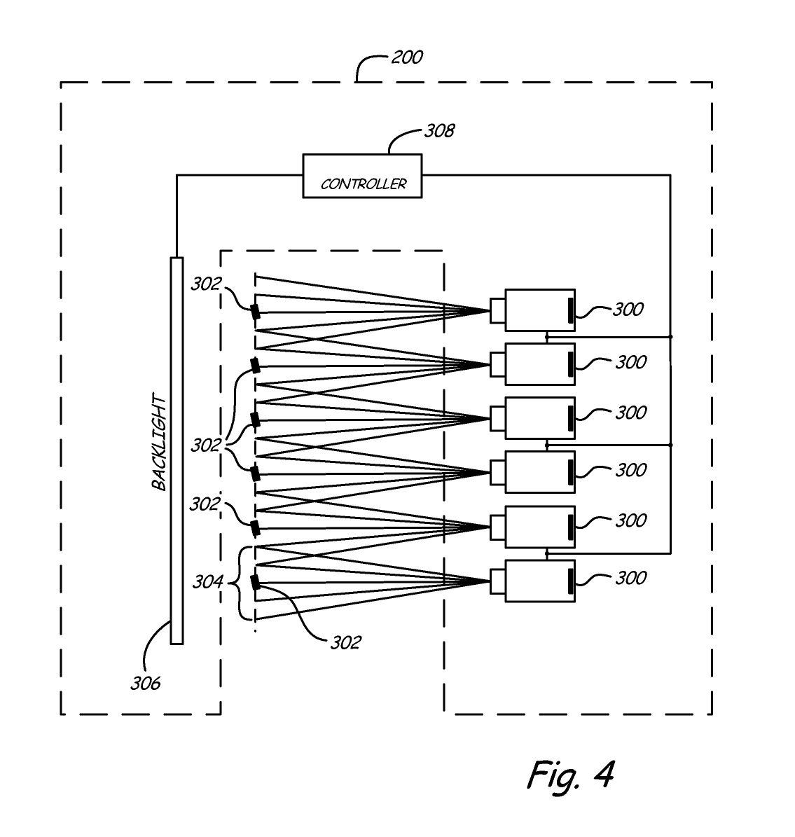

FIG. 4 is a diagrammatic top plan view of a plurality of components being detected using a plurality of two-dimensional image detectors in accordance with an embodiment of the present invention. FIG. 4 shows a plurality (six) of small two-dimensional cameras viewing backlit components 302 as components 302 are held by respective nozzles. Each camera 300 includes a field of view (FOV) 304 that preferably overlaps the FOV of at least one of its neighbors. Each camera 300 includes a two-dimensional imaging detector array and focusing optics that create a focused image of a plane nominally containing the nozzle axis (extending into and out of the page of FIG. 4) of an SMT component placement head. A diffuse illumination screen 306 is placed behind the components 302 approximately along the optical axis of the cameras 300 to create a backlit shadow image of the component(s). The cameras can be telecentric, but, in a preferred embodiment, the cameras are not telecentric, thereby allowing the optics to be very compact and the FOV 304 of the cameras 300 to be larger than the physical dimensions of the cameras 300. Each camera 300, as well as backlight illuminator 306 is coupled to controller 308, which may be any suitable computing device, such as a microprocessor or digital signal processor. Controller 308 is configured, through hardware, software or a combination thereof, to determine offset and orientation information of the component(s) based upon a plurality of backlit shadow images detected by the plurality of two-dimensional cameras 300 and provide the offset and orientation information to a controller of the pick and place machine.

Typically, the components 302 are rotated around their respective nozzle axes while a sequence of images is collected. Software algorithms, resident in on-board electronics or in ancillary processing modules or computers, calculate the location of shadow edges in a sequence of images and process the sequence to determine the position and orientation of each component.

The component is typically edge-on as viewed by the camera, with the axis of rotation of the component perpendicular to the camera's optical axis, though the device will function with the component or rotation axis tipped at an angle so that the component does not present a purely edge-on view to the camera.

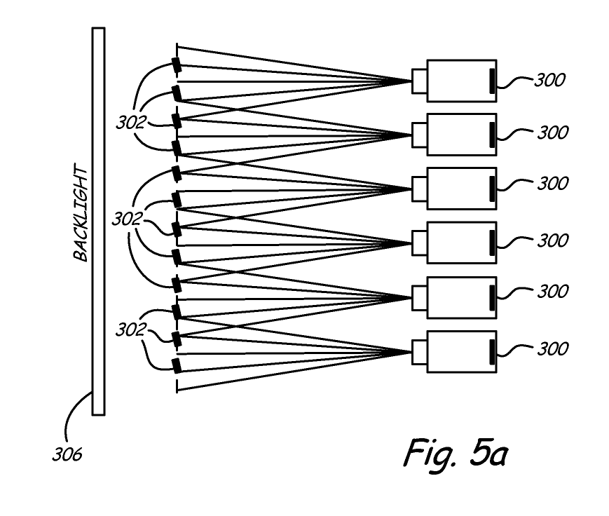

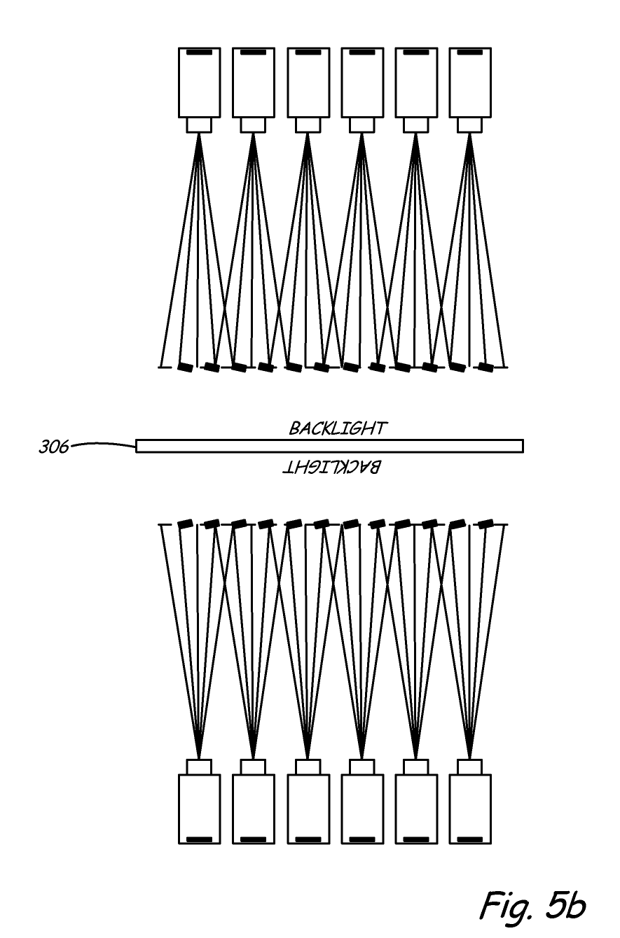

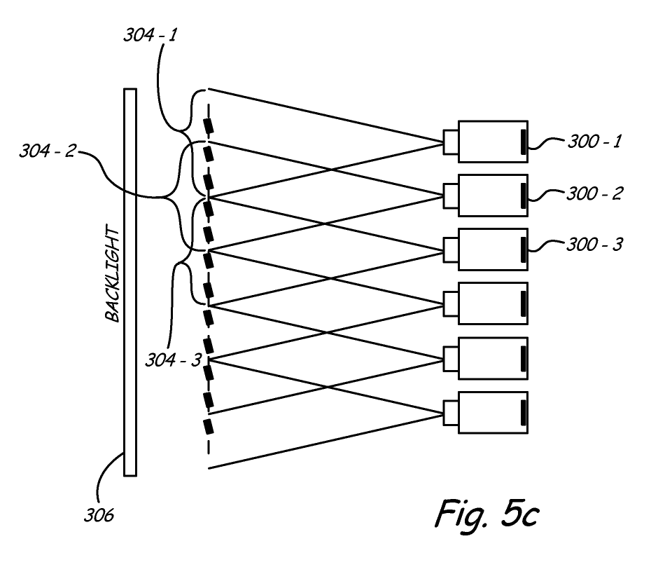

FIG. 5a is a diagrammatic top plan view of a plurality of components being detected using a plurality of two-dimensional image detectors in accordance with another embodiment of the present invention. FIG. 5a is similar to FIG. 4, but illustrates an embodiment of the present invention where a single two-dimensional camera 300 is able to provide position and orientation information for a plurality of components 302. Specifically, in FIG. 5a, six cameras 300 can detect position and orientation information for twelve components 302.

FIG. 5b is a diagrammatic top plan view of a plurality of components being detected using a plurality of two-dimensional image detectors in accordance with another embodiment of the present invention. FIG. 5b is similar to FIG. 5a but illustrates illumination from backlight illumination generator 316 being used in two directions. In this embodiment, 12 two-dimensional cameras are able to detect position and orientation information for twenty four components.

FIG. 5c is a diagrammatic top plan view of a plurality of components being detected using a plurality of two-dimensional image detectors having overlapping fields of view in accordance with an embodiment of the present invention. FIG. 5c illustrates an embodiment where the fields of view 304 are deliberately chosen so that there is an approximate 50% overlap between neighboring fields of view. Specifically, field of view 304-1 of camera 300-1 overlaps about half of field of view 304-2 of camera 300-2. Similarly, field of view 304-2 overlaps half of field of view 304-3 and so on. Thus, most components are viewable by two distinct cameras from differing points of view. This is advantageous in that stereoscopic vision processing and techniques can be used to sense aspects of depth to increase speed and/or accuracy or even provide diagnostic information about the component pose on the nozzle.

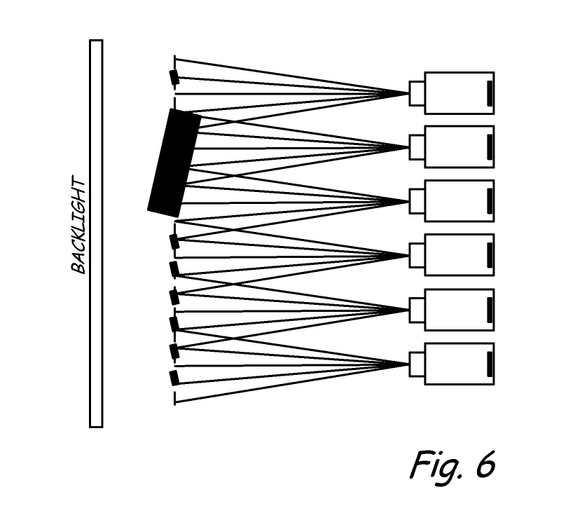

FIG. 6 is a diagrammatic top plan view of a plurality of components of different sizes being detected using a plurality of two-dimensional image detectors in accordance with an embodiment of the present invention. This feature is beneficial because a pick and place machine may place components of different sizes at the same time. Thus, embodiments of the present invention are able to accommodate such different sized components easily.

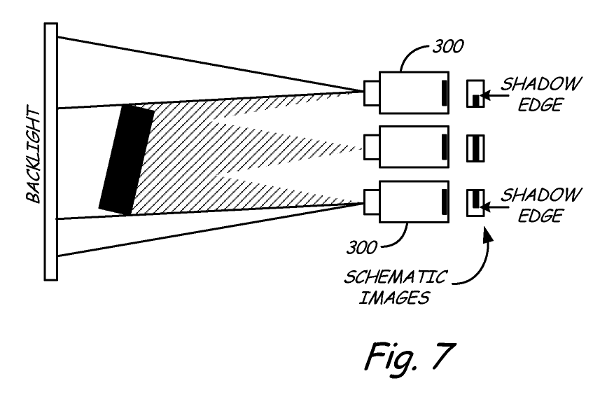

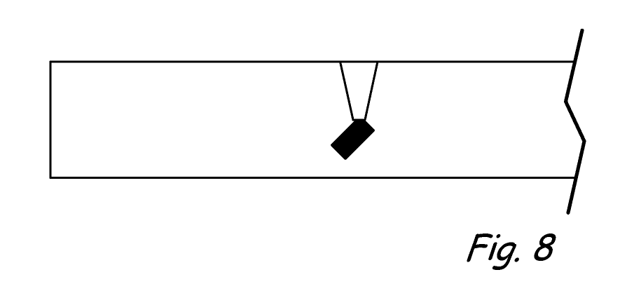

FIG. 7 is a diagrammatic top plan view of a single large component being detected using a plurality of two-dimensional image detectors in accordance with an embodiment of the present invention. Each of three different cameras 300 detects a portion of the backlit shadow image. The edges of the backlit shadow image of the single component may be detected by one or more cameras. The ability to detect component position and orientation for very large components is also useful in pick and place machine operation. Images of components that substantially fit within a FOV allow analysis of the outline of the backlit shadow image for proper or improper pose prior to placement.

FIG. 8 is a diagrammatic view of an improperly picked component being held on a nozzle. This is a condition that is detectable using embodiment of the present invention.

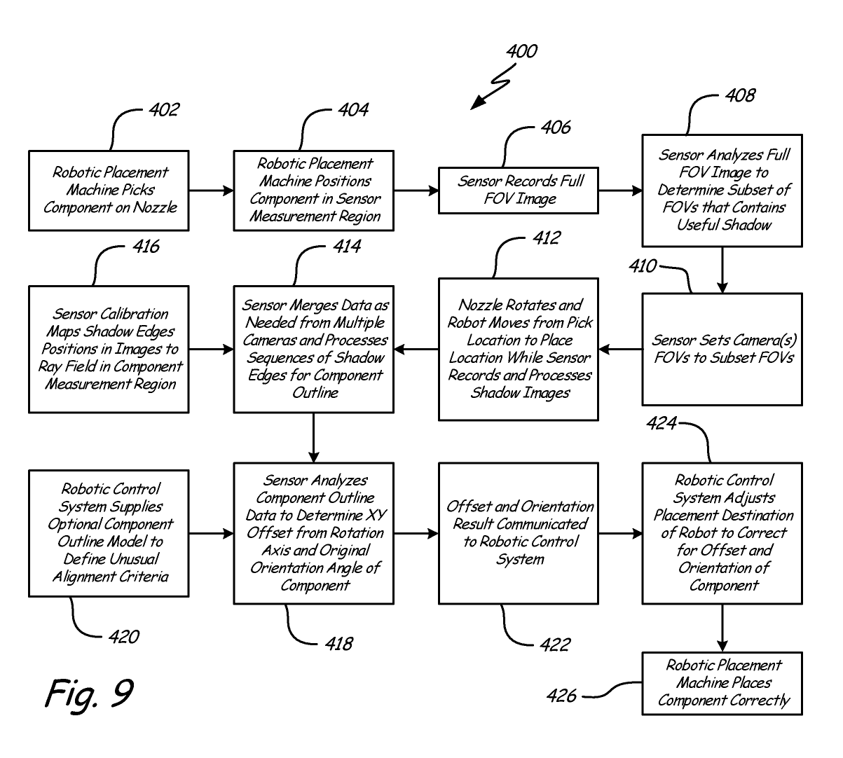

FIG. 9 is a flow diagram of a method of detecting component position and alignment after a pick operation in accordance with an embodiment of the present invention. Method 400 begins at block 402 where the pick and place picks a component on a nozzle. Next, at block 404, the pick and place machine positions the component in the sensor measurement region. At block 406, the sensor records a full field of view image. At block 408, the sensor analyzes the full field of view image to determine a subset of fields of view that contain the useful shadow of the component. Next, at block 410, the sensor sets the camera(s) fields of view to the selected subset field of view. At block 214, the nozzle rotates the component while the sensor records and processes the backlit shadow images. Preferably, during the execution of block 412, the pick and place machine is moving the component from the pick location to the intended placement location on the workpiece. At block 414, the sensor merges data, as needed, from multiple cameras and processes sequences of shadow edges to determine a component outline. Additionally, sensor calibration can map shadow positions in images to ray fields in the component measurement region as indicated at block 416. At block 418, the sensor analyzes component outline data to determine XY offset from the rotational axis and original orientation angle of the component. The pick and place machine can supply an optical component outline model to define any unusual alignment criteria, as indicated at block 420. Next, at block 422, the offset and orientation result are communicated to the pick and place machine's control system. At block 424, the pick and place machine adjusts the placement destination to correct for offset and orientation of the component. Finally, at block 426, the pick and place machine correctly places the component.

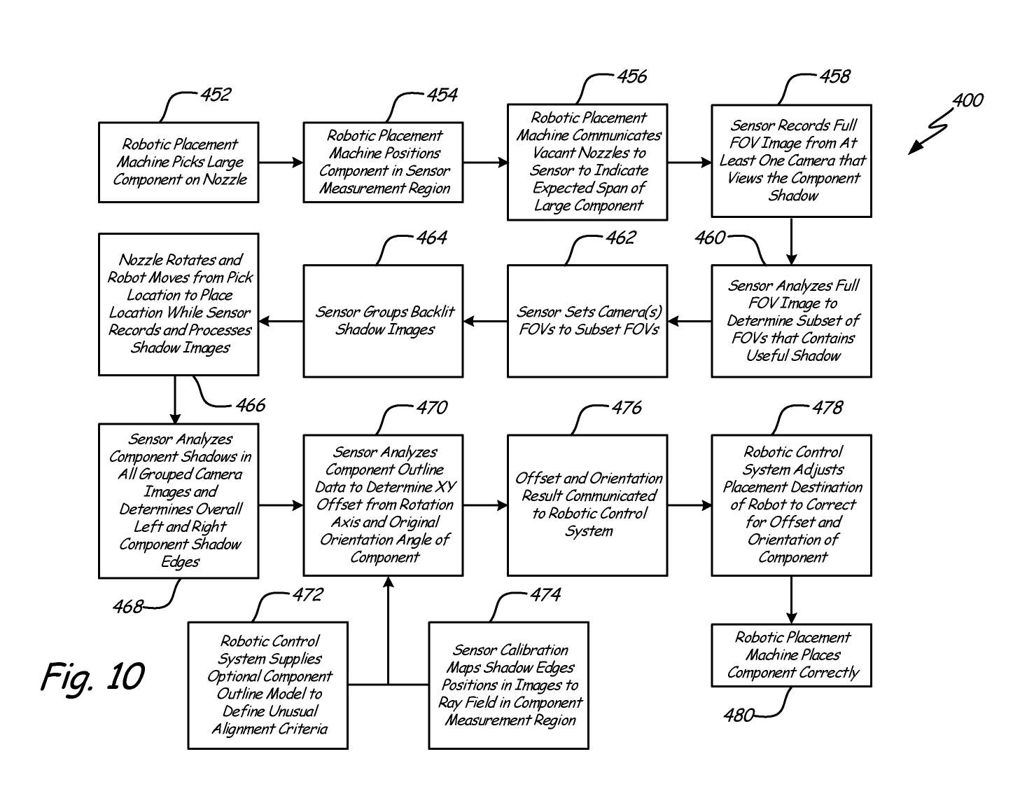

FIG. 10 is a flow diagram of a method of detecting component position and alignment after a pick operation in accordance with another embodiment of the present invention. Method 450 begins at block 452 where a pick and place machine picks a large component and retains the component on a nozzle. Next, at block 454, the pick and place machine positions the component in a sensor measurement region. At block 456 the pick and place machine communicates vacant nozzles to the sensor to indicate an expected span of the large component. At block 458, the sensor records a full field of view image from at least one camera that views the component shadow. At block 460, the full field of view image is analyzed, preferably by the sensor, to determine a subset field of view that contains useful shadow information. At block 462, the sensor sets a plurality of cameras to the selected subset field of view. At block 464, the sensor groups backlit shadow images. Next, at block 466, the nozzle rotates while the pick and place machine moves the component from a pick location to a place location while the sensor records and processes backlit shadow images. At block 468, the sensor analyzes component shadows in all grouped camera images and determines overall left and right component shadow edges. At block 470, the sensor analyzes component outline data to determine XY offset from rotation axis and original orientation angle of the component. The pick and place machine may supply an optional component outline model to define unusual alignment criteria, as indicated at block 472. Sensor calibration maps shadow edge positions in images to ray field in the component measurement region, as indicated at block 474. At block 476, the offset and orientation results are communicated to the control system of the pick and place machine. At block 478, the control system adjusts placement destination of the pick and place machine to correct for offset and orientation of the component. Finally, at block 480, the pick and place machine places the component correctly.

While embodiments of the present invention are believed to provide a number of advances in the art of component offset and orientation determination, it is still important that the sensor be accurately calibrated to map detector pixel position to illumination field ray position and direction in order to properly calculate component position and orientation from the detected shadow.

Although the present invention has been described with reference to preferred embodiments, workers skilled in the art will recognize that changes may be made in form and detail without departing from the spirit and scope of the invention.

What is claimed is:

1. A sensor for sensing component offset and orientation when held on a nozzle of a pick and place machine, the sensor comprising:
a plurality of two-dimensional cameras, each camera having a field of view that includes a nozzle of the pick and place machine;
a backlight illuminator configured to direct illumination toward the plurality of two-dimensional cameras, the backlight illuminator positioned on an opposite side of a nozzle from the plurality of two-dimensional cameras; and
a controller coupled to the plurality of two-dimensional cameras and the backlight illuminator, the controller being configured to determine offset and orientation information of the component based upon a plurality of backlit shadow images detected by the plurality of two-dimensional cameras and provide the offset and orientation information to a controller of the pick and place machine.

2. The sensor of claim 1, wherein a field of view of a first camera of the plurality of cameras overlaps a field of view of a second camera of the plurality of cameras.

3. The sensor of claim 2, wherein the overlap is approximately half of a field of view.

4. The sensor of claim 1, wherein at least one camera includes non-telecentric optics.

5. The sensor of claim 4, wherein all cameras include non-telecentric optics.

6. The sensor of claim 1, wherein all cameras are substantially aligned with one another in a direction that is substantially perpendicular to an optical axis of one camera.

7. The sensor of claim 1, wherein the backlight illuminator is a diffuse backlight illuminator.

8. The sensor of claim 1, wherein the sensor is configured to provide offset and orientation information for a plurality of components substantially simultaneously.

9. The sensor of claim 8, wherein the number of components is equal to a number of cameras comprising the plurality of cameras.

10. The sensor of claim 8, wherein the components are of different sizes.

11. The sensor of claim 8, wherein the number of components is greater than a number of cameras comprising the plurality of cameras.

12. A method of sensing at least one component held on at least one respective nozzle in a pick and place machine, the method comprising:
positioning the at least one component in a measurement region of a sensor;
recording a full field of view image of the at least one component;
analyzing the full field of view image to select a subset field of view;
setting the at least one two-dimensional camera to the subset field of view;
rotating the nozzle while recording backlit shadow images of the subset field of view;
analyzing the backlit shadow images to determine offset and orientation information relative to the at least one component; and
providing the offset and orientation information to a pick and place machine controller.

13. A method of sensing at least one component spanning the fields of view of a plurality of two-dimensional cameras, the method comprising:
positioning the at least one component in a measurement region of a sensor;
recording a full field of view image of the at least one component;
analyzing the full field of view image to select a subset field of view;
setting the plurality of two-dimensional cameras to the subset field of view;
rotating the nozzle while recording backlit shadow images of the subset field of view from the plurality of two-dimensional cameras;
analyzing the backlit shadow images from the plurality of two-dimensional cameras to determine the backlit shadow images from the plurality of two-dimensional cameras that contain shadow edges;
merging the sequence of shadow edges;
determining offset and orientation information relative to the at least one component; and
providing the offset and orientation information to a pick and place machine controller.

14. The method of claim 13, and further comprising placing the at least one component on a workpiece using the offset and orientation information.

15. The method of claim 13, and further comprising calibrating shadow edge positions in images to ray fields in a component.
